(19) United States
(12) Patent Application Publication
(10) Pub. No.: US 2011/0225059 A1
(43) Pub. Date: Sep. 15, 2011

(54) POS SALES TRANSACTION SAFETY NET

(76) Inventor: Judy L. Mittag, Austin, TX (US)

(21) Appl. No.: 13/046,019

(22) Filed: Mar. 11, 2011

Related U.S. Application Data
(60) Provisional application No. 61/313,335, filed on Mar. 12, 2010.

(51) Int. Cl. G06Q 20/00

(52) U.S. Cl. 705/21

(57) ABSTRACT

A method for monitoring a register is provided which comprises (a) providing a register having associated therewith (i) an electronic journal which resides on a hosting server separate from the register, and which receives digitally transmitted records of all transactions occurring at a register, and (ii) a secure, nonvolatile memory device which stores sales transaction data for the register; (b) determining whether the memory device associated with the register has sales transactions with a date within a specified date range; (c) if the memory device does not have sales transactions with the specified date range, then marking the memory device as having been examined for transactions in the specified date range; (d) if the memory device does have sales transactions with the specified date range, then determining whether the transaction data stored therein corresponds to the transaction data stored in the register's electronic journal for the specified date range; (e) if the transaction data stored in the memory device corresponds to the transaction data stored in the register's electronic journal, then marking the memory device as having been examined for transactions in the specified date range; and (f) if the transaction data stored in the memory device does not correspond to the transaction data stored in the register's electronic journal, then marking the memory device as having been examined, initiating a data recovery process and generating a notice of the discrepancy.

### CROSS-REFERENCE TO RELATED APPLICATION

This application claims the benefit of U.S. Provisional Application No. 61/313,335, filed Mar. 12, 2010, having the same title and the same inventor, and which is incorporated herein in its entirety.

### FIELD OF THE DISCLOSURE

The present disclosure relates generally to data backup systems, and more particularly to data backup solutions for sales transactions at a POS register which permit the remote recovery of sales data, which has been overwritten during a reimaging of the register.

### BACKGROUND OF THE DISCLOSURE

Reimaging computers in retail stores at points of sale (POS) registers (that is, the process of formatting, partitioning, and reloading software onto register hard drives) is a common and frequent necessity across retail chains for a variety of acceptable reasons. Many consumer retail chains suffer millions of dollars of losses in annual revenues from inadvertent erasure of sales transaction data from POS registers during the re-imaging process. These are sales at the POS that, for whatever reason, were not transmitted to the store's electronic journal (EJ) (the digital equivalent of a general ledger sales journal), before the reimaging process was initiated. Until recent years, the risk of inadvertent erasure of this sales data was mitigated by containment to the carelessness of trained IT technicians at a corporate help desk. For decades, the standard best practice for reimaging computers across an enterprise network provided a complete audit trail of accountability and responsibility. Under this practice, the store was required to call the help desk. The help desk would then open a ticket and, after entering confirmation of the caller to make this request, would undertake a best effort to ascertain that all the sales transactions on the target register had been transmitted to the store's EJ. An electronic signature of the help desk technician who initiated the reimaging process would also be included. To date, loss of sales transactions in this manner is accepted as an SOP business risk/expense.

In recent years, the developers of self-imaging software applications which serve small to medium local business chains adequately, have made inroads into large to very large corporate retail enterprise operations that span whole countries. With this self-imaging software, any employee in a store, who has been shown which few buttons to push, is able to initiate the reimaging process at will.

The loss of sales data due to self-imaging registers can be expected to multiply exponentially, because the risk containment and audit trail of the reimaging process are eliminated. Exposure has escalated from a few hundred trained IT technicians to however many thousands of retail employees across the corporate enterprise and vendors' technicians who service the POS registers. There are many store employees and vendor technicians who comprehend and heed the significance of precautionary steps to avoid loss of sales data during the reimaging process. However, it is a documented fact that there are far more who do not, or in the rush of business simply forget to do so. In addition, self-imaging at-will in the stores introduces a new opportunity for cashiers to commit undetected theft without the safety of an audit trail.

### BRIEF DESCRIPTION OF THE DRAWINGS

FIG. 1 is a flowchart depicting a first particular, non-limiting embodiment of the methodologies described herein.

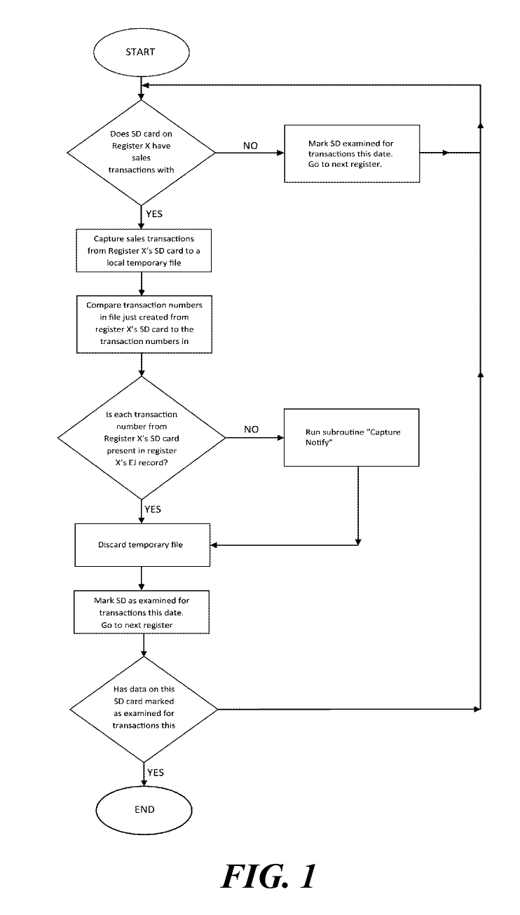

### SUMMARY OF THE DISCLOSURE

In one aspect, a method for monitoring a register is provided which comprises (a) providing a register having associated therewith (i) an electronic journal which resides on a hosting server separate from the register, and which receives digitally transmitted records of all transactions occurring at a register, and (ii) a secure, nonvolatile memory device which stores sales transaction data for the register; (b) determining whether the memory device associated with the register has sales transactions with a date within a specified date range; (c) if the memory device does not have sales transactions with the specified date range, then marking the memory device as having been examined for transactions in the specified date range; (d) if the memory device does have sales transactions with the specified date range, then determining whether the transaction data stored therein corresponds to the transaction data stored in the register's electronic journal for the specified date range; (e) if the transaction data stored in the memory device corresponds to the transaction data stored in the register's electronic journal, then marking the memory device as having been examined for transactions in the specified date range; and (f) if the transaction data stored in the memory device does not correspond to the transaction data stored in the register's electronic journal, then initiating a data recovery process by generating a notice of the discrepancy.

In another aspect, a system for monitoring registers is provided which comprises (i) a plurality of registers, (ii) an electronic journal which resides on a hosting server physically separate from the register, and which receives and stores digitally transmitted records of all transactions occurring at a register, and (iii) a secure, nonvolatile memory device installed inside a register's computer; which receives and stores exact duplications of all sales transactions recorded onto the hard drive of the register; and computer software, disposed in a tangible medium, and containing suitable instructions for (a) determining whether a memory device associated with a register has sales transactions with a date within a specified date range, (b) if the memory device does not have sales transactions with the specified date range, then marking the memory device as having been examined for transactions in the specified date range, (c) if the memory device does have sales transactions with the specified date range, then determining whether the transaction data stored therein corresponds to the transaction data stored in the store's electronic journal for the specified date range, (d) if the transaction data stored in the memory device corresponds to the transaction data stored in the store's electronic journal, then marking the memory device as having been examined for transactions in the specified date range, and repeating this process a each register, (e) if the transaction data stored in the memory device does not correspond to the transaction data stored in the register's electronic journal, then initiating a recovery routine and generating a notice of the discrepancy, and then repeating this process at each register.

### DETAILED DESCRIPTION

The common knowledge that loss of data from careless reimaging is an accepted business expense, combined with the new self-imaging enablement in the stores and no accountability record, has escalated a critical vulnerability existing at the registers. In particular, a clever, unethical cashier bent on stealing from their tills can now easily deduce how to leverage the new “no accountability reimaging” practice to commit theft, and with little to no chance of detection or evidence to lead to prosecution.

Currently, there are two main types of cashier theft detection/deterrent systems known to the art. The first of these are video surveillance systems, such as closed circuit TV (CCTV). While these systems may reduce losses, the placement of cameras is easily known to associates operating a register, thus making planned avoidance of that security deterrent possible.

The second type of cashier theft detection/deterrent system known to the art relies on vault balancing tills to the electronic journal (EJ) records of the registers and cashier IDs. This is null balancing when data on the register in question is overwritten with a fresh image to the hard drive. A cashier intent on theft need follow only a few steps—all of which are within normal activities and responsibilities for their position, and so can be done without arousing suspicion—and steal with almost a sense of impunity, even over a period of time, until they get greedy or careless or are caught by camera.

For example, a cashier intent on stealing can perform the following steps:

(1) Process only a few customers, take the register offline, and then continue processing customers as normal.
(2) At the end of their shift at that register, as long as no one noticed the register was offline and took corrective action to put it back online, reconnect the register to the network, and go directly to reimaging before leaving the register, effectively overwriting all evidence of sales transacted after the register was taken offline.
(3) If the offline was not detected and corrected during their shift, then in a camera safe location on their way back to the vault to turn in their till, remove whatever receipts they choose to steal, leaving whatever is deemed necessary to delay suspicions.
(4) Mention to the vault that they had to reimage the register, offering any one of the current most common register issues known to be corrected by reimaging, and that they forgot to check the EJ before doing it.

It is a common standard for point-of-sale (POS) system alerts to include an “offline” flag to EJs when registers go offline as a heads up that there is the potential for sales data that was not transmitted to the EJ unless the register was brought back online during that same shift. In this manner, the EJ flag supports the cashier's cover-up because the register must be online to be reimaged.

This security gap could remain a threat at the level of only isolated cashier thefts here and there. However, it could also be exploited by an entrepreneurial criminal who conceives a “ring” of cashier thieves and serial thefts to coincide with hiring for high volume or seasonal events when the risk of being discovered is reduced. Even with all best practices followed, with careful thieves and reliance on CCTV and till-to-EJ balancing, there is no way to prove sales transactions were actually lost before the reimaging, and hence, there is no way to know or prove that a theft occurred.

There is thus a need in the art for a system and methodology of preventing till theft at cash registers. The solution should preferably provide “same day” automated capability for IT to be made aware of a sales transaction data loss event, enable remote recovery of the transactions overwritten on the register along with the user ID of the person who may be responsible, and support corrective coaching for associates and vendor technicians. Moreover, when applicable, the solution should preferably produce substantive evidence for the probability of theft and a suspect.

To be cost effective, the solution should preferably use common hardware technology that can be easily integrated onsite or before shipping, as easily and cost effective as can be a new hard drive. The solution should be in compliance with corporate network security policies and current government accounting regulations (SOX and PCI) in as much as these are implemented in the existing POS systems.

The solution should also restore accountability for the reimaging process equivalent to the audit trail provided by a help desk assisted reimaging process; facilitate remote secure access of the loss event from start to end points for IT, store and loss prevention management, and corporate accounting. The solution should create/preserve an access audit trail. The solution should also provide detection and recovery benefits for both the careless and intentional causes for lost sales transactions at registers attributable to being overwritten by reimaging.

Without diminishing the considerable benefits of self-imaging enabled in stores, the solution should close the loss prevention gap and the logically expected, exponentially greater losses to come with the lack of accountability inherent with self-imaging. The solution should also mitigate or nullify the escalated risk for cashier theft as unethical store associates deduce how to leverage the self-imaging capability for their own financial gain. The aforementioned goals may be met with the systems and methodologies disclosed herein.

The point-of-sale (POS) sales data safety net cashier theft detection solution disclosed herein enables remote recovery of intact sales transaction data from a register, even after the data on the hard drive is overwritten by reimaging or the hard drive was rendered incapable of transmitting its' sales data to the store's electronic journal. Moreover, as long as a register is on line at the end of the day for closing, the theft detection routine will check it for transaction discrepancy to the EJ for that day. The solution also preferably maintains a transactions audit trail apart from the EJ for as long it as needed by concerned teams whenever there is a contradiction of actual transactions at a register to be equal to sales dollars in the EJ. The solution also preferably maintains evidentiary proof of probable cause when such a contradiction occurs.

In the preferred embodiment, the system consists of a common, easily integrated hardware accessory disposed inside the register computer, conservative new instructions related to POS software and a routine that is run on the existing point of sale processor server or other intermediate platform that is in-line for staging sales transactions to the EJ, and a new task for a designated authorized IT team. This safety net/theft detection solution is in compliance with all current security and accounting policies encountered by the process, including PCI and SOX.

The sales transaction data is duplicated onto a card internal to the register and physically separate from the register's hard drive. A software routine run from the point of sales processor does a register sales confirmation to the EJ after business hours, securing related data when there is an indication that sales transactions are missing from the EJ, and then generates an alert notification to the IT team to follow up. The IT team takes over for eyes-on review and applicable management notification, after which the appropriate remediation responses are made by store management. When there is reason to suspect a theft was committed, there is appropriate carry-over to the loss prevention management team.

The systems and methodologies described herein may be implemented with a memory device such as secure digital (SD) or other such compact read/write card, which may be mounted inside or at each cash register. For expediency, the designation “SD card” is used in this document for that functional component. It is to be noted, however, that the SD card does not duplicate the functions served by the hard drive. The SD card does not host POS software, tax tables, SKUs, etc., and it is never referenced by any sales processing code or the re-imaging software or process. The SD card is reserved only for the secure temporary storage of sales transaction data for the register in which it resides.

The software used to implement the systems and methodologies described herein, and in particular, the software used for the duplication, EJ verification, and automated notification, preferably has two components. The first component consists of an instruction added to the existing POS code to duplicate sales transactions data onto the SD card after it is written to the local hard drive and before it exits to the network for transmission across the network into the store EJ. The second component consists of a new business closing task routine¹ that runs on a daily basis after hours to confirm that transaction numbers on the SD card at each register are present in the EJ. When there is a discrepancy, the routine facilitates secure remote investigation and recovery via a “sales transaction discrepancy file created on the PSP server, or its equivalent intermediary platform to the EJ, and then sends an alert message to the IT team, who then follows though². ¹See Attachment A: Flow Chart: PSP/POS Safety Net in “layman's language”, P12²See Attachment B: Process: Follow Up to PSP Discrepancy Notification, P13

Sales transaction data is retrieved from a register's SD card into a temporary file on the point of sale processor server or platform. The file is saved and made accessible for review or follow up actions by specified IT and store employees only when a discrepancy is detected between a register's EJ record and the transactions on its SD card, and only by those employees who are authorized to review confidential accounting and personnel information, thus conforming to existing integrity, security and confidentiality of those financial systems.

Sales transaction data is retrieved from a register's SD card into a file on the point of sale processor server or intermediary staging server to the EJ. The file is saved and made accessible for review or follow-up actions by specified IT and store employees only when a discrepancy is detected between a register's EJ record and the transactions on its SD card, and only by those IT and store employees who are authorized to review confidential accounting and personnel information, thus conforming to existing integrity, security and confidentiality.

The systems and methodologies described herein may offer the following benefits:

(a) Elimination of potential for millions of dollars in sales transactions lost to the EJ because best practice for reimaging register hard drives was not followed, or intentional to cover cashier theft.
(b) SD card genre of technology is a proven redundant data strategy used in technology common to retail operations such as the flash drive accessory for additional storage space for laptops used by store management enabling them to work from home.
(c) The physical storing and various necessary accessing of sales transaction data is configurable to industry standard and proprietary POS systems, applicable accounting (SOX, PCI) practices and network security policies in as much as the store is in compliance.
(d) Accountability for reimaging over sales data is restored. The cashier who rang up the missing sales transactions is discovered from the redundant transaction data captured to the point of sale processor hosting server, providing a starting point to determine probable responsibility for negligent reimaging of a register or a potential theft suspect.
(e) Redundant transactions are not written to a partitioned hard drive in the register, which would add seconds to customer processing, and no responses from the cashier are needed, thus making the solution transparent to the cashier and customer.
(f) Suspect register sales data is captured to the PSP with access control as secure and assignable as is common on any enterprise capable network operation system.
(g) The solution can utilize existing overnight IT personnel for proactive remediation follow through so as not to degrade support to the stores during business hours.

In addition to the foregoing, with the capability for IT to retrieve sales data remotely from other than the hard drive of a register, the systems and methodologies described herein also eliminate the need for vendor service calls and data recovery labs for the recovery of sales data from most problematic registers, as long as the register is reachable across the network. Hardware issues do not always result in permanent loss of sales data. However, when this happens today, a vendor technician is typically dispatched onsite to take a second register down to be used to facilitate recovery of missing or potentially missing sales data from the hard drive of a problem register, before other hardware services can be undertaken. This incurs costs and potentially inconveniences customers. If the attempted retrieval at a working register is unsuccessful, recovery costs increase the data recovered by a more labor-intensive data recovery lab at a higher cost.

This solution can also augment sales data retrieval processes used in emergencies when the safety of human life must take precedence over preservation of that last few hours of sales data.

The above description of the present invention is illustrative, and is not intended to be limiting. It will thus be appreciated that various additions, substitutions, and modifications may be made to the above-described embodiments without departing from the scope of the present invention. Accordingly, the scope of the present invention should be construed in reference to the appended claims.

### ATTACHMENT A

### Flow Chart: PSP/POS Safety Net

1. Save temporary file to protected file named “Register X Discrepancy”
2. Make file “Read Only” requiring rights assigned to IT technicians for that server, and the same store management user group that has access to confidential sales and employee
3. Delete rights on this file, for obvious multiple compliance reasons, should be highly restricted. Since with or without theft, it is a loss prevention issue, perhaps the loss prevention management team should be the only one with the right to call delete for this file.
4. Create message “Store xxxx Register X Discrepancy in SD to EJ sales transaction numbers”, then send to designated overnight IT team for review and follow up
5. Appropriately log completion of Capture Notify tasks into log file
6. Exit and Resume main routine

### ATTACHMENT B

### Process: Follow Up to PSP Discrepancy Notification

This is an applicable process for an IT overnight team associate to follow in response to the notification sent by the PSP/POS Safety Net routine.

Subject line and only necessary content of notification sent to IT recovery team
“Store 6954 Register 15 Discrepancy in SD to EJ sales transaction numbers”

### IT Team Follow Up Process

Create the standard help desk ticket for this type of activity, then log into the server hosting the discrepancy file and review the discrepancy file created by the Capture Notify routine, visually comparing the transactions in it to the transactions for Register 15 in the store's electronic journal.
When all transactions in the PSP discrepancy files are indeed also present in the register's EJ records,
   1. Notify the team who owns the notification routine that a false discrepancy file was created in the store, please delete it.
   2. Close out your ticket with applicable generic notation; do not include specifics from the discrepancy file, no follow up email to the store is necessary—EJ is complete.
When there are_transactions in the PSP discrepancy file that are not recorded for that register in the EJ, use the email template below to guide you in completing this task.

Information to include in the email sent out to designated management when sales transaction data is missing from the EJ
1. Ticket number created for this investigation and the store involved
2. Which register, which transaction numbers are missing from the EJ, what is the cashier ID responsible for transactions missing from the EJ
3. Did the EJ reflect a corresponding “Offline” flag for this register, and if so, what is the time frame coincidence of that flag in the EJ and the missing transactions in the discrepancy file
4. After investigation of related, reliable resources, indicate whether or not you could discover that a vendor may have been onsite to service registers
5. Disclose how they can access the relevant discrepancy file
6. Closing scripted remarks would include
   Store management is to follow up with the applicable personnel and LPM corrective processes based on whether it was negligent overwriting because someone did not follow best practices for checking EJ before reimaging; or, is it a potential theft situation?
   Vault to follow up according to related corporate revenue accounting processes

Close out the ticket only with general appropriate notation, notating email sent and notating email sent and list of recipients. Any employee identification discovered in review of the discrepancy file should be omitted from the help desk ticket for confidentiality reasons.

What is claimed is:

1. A method for monitoring a register, comprising:
(a) providing a register having associated therewith (i) an electronic journal which resides on a hosting server separate from the register, and which receives digitally transmitted records of all transactions occurring at a register, and (ii) a secure, nonvolatile memory device which stores sales transaction data for the register;
(b) determining whether the memory device associated with the register has sales transactions with a date within a specified date range;
(c) if the memory device does not have sales transactions with the specified date range, then marking the memory device as having been examined for transactions in the specified date range;
(d) if the memory device does have sales transactions with the specified date range, then determining whether the transaction data stored therein corresponds to the transaction data stored in the register's electronic journal for the specified date range;
(e) if the transaction data stored in the memory device corresponds to the transaction data stored in the register's electronic journal, then marking the memory device as having been examined for transactions in the specified date range; and
(f) if the transaction data stored in the memory device does not correspond to the transaction data stored in the register's electronic journal, then marking the memory device as having been examined, initiating a data recovery process and generating a notice of the discrepancy.

2. The method of claim 1, wherein determining whether the memory device associated with the register has sales transactions with a date within a specified date range includes:
retrieving the sales transaction data for the specified date range from the memory device to a temporary file on a secure hosting server; and
comparing the sales transaction data in the local file with the sales transaction data for the specified date range from the electronic journal.

3. The method of claim 2, wherein the sales transaction data in the local file includes a transaction number for each transaction recorded therein, and wherein the sales transaction data in the electronic journal also includes a transaction number for each transaction recorded therein.

4. The method of claim 3, wherein comparing the sales transaction data in the local file with the sales transaction data for the specified date range from the register's electronic journal includes comparing the transaction numbers in the local file with transaction numbers in the electronic journal.

5. The method of claim 1, further comprising:
if a notice of discrepancy is generated, then discarding the temporary file.

6. The method of claim 1, further comprising:
if a notice of discrepancy is generated, then marking the memory device as having been examined for transactions in the specified date range.

7. The method of claim 1, wherein the specified date range is the day upon which the memory device is being examined for transactions.

8. The method of claim 1, wherein the memory device is a secure digital (SD) card.

9. The method of claim 1, wherein the memory device is password protected.

10. The method of claim 1, wherein the memory device is not accessible by the operator of the register.

11. The method of claim 2, wherein generating a notice of the discrepancy comprises:
saving the temporary file to a protected file.

12. The method of claim 11, wherein the protected file is a read-only file.

13. The method of claim 2, wherein generating a notice of the discrepancy comprises:
generating a message concerning the discrepancy.

14. The method of claim 12, wherein the register is disposed in a retail outlet, and wherein the temporary file is accessible only by IT personnel and management associated with the retail outlet.

15. The method of claim 1, wherein the register is a plurality of registers, and wherein steps (b) through (f) are applied to each of the plurality of registers.

16. A system for monitoring registers, comprising:
a plurality of registers, each having associated therewith (i) an electronic journal which tracks transactions occurring at the register, and (ii) a secure, nonvolatile memory device which stores sales transaction data for the register; and computer software, disposed in a tangible medium, and containing suitable instructions for
(a) determining whether a memory device associated with a register has sales transactions with a date within a specified date range;
(b) if the memory device does not have sales transactions with the specified date range, then marking the memory device as having been examined for transactions in the specified date range;
(c) if the memory device does have sales transactions with the specified date range, then determining whether the transaction data stored therein corresponds to the transaction data stored in the register's electronic journal for the specified date range;
(d) if the transaction data stored in the memory device corresponds to the transaction data stored in the register's electronic journal, then marking the memory device as having been examined for transactions in the specified date range; and
(e) if the transaction data stored in the memory device does not correspond to the transaction data stored in the register's electronic journal, then generating a notice of the discrepancy.

17. The system of claim 15, further comprising a network.

18. The system of claim 16, wherein the computer software is installed on a computer that has access to said plurality of registers by way of said network.
